(19) United States
(12) Patent Application Publication
(10) Pub. No.: US 2011/0159463 A1
(43) Pub. Date: Jun. 30, 2011

(54) DEVICE FOR TREATING HUMAN KERATINOUS MATERIAL

(75) Inventor: Henri Samain, Bievres (FR)

(73) Assignee: L'OREAL, PARIS (FR)

(21) Appl. No.: 13/001,671

(22) PCT Filed: Jul. 10, 2009
(86) PCT No.: PCT/IB2009/053012

§ 371 Date: Feb. 23, 2011

Related U.S. Application Data
(60) Provisional application No. 61/083,405, filed on Jul. 24, 2008.

(30) Foreign Application Priority Data
Jul. 10, 2008 (FR) 08 03951

(51) Int. Cl. A45D 44/00; G09B 19/00

(52) U.S. Cl. 434/100; 601/17

(57) ABSTRACT

A method of making up human keratinous material, the method including: acquiring at a first location and storing a starting image and/or starting relief of keratinous material; and reproducing on keratinous material of the same type an image for reproduction and/or relief for reproduction corresponding to the starting image and/or relief, possibly after performing processing, the image and/or relief for reproduction being reproduced at a second location that is different from the first location.

The present invention relates to devices for treating human keratinous material, and to methods of applying makeup.

### BACKGROUND

Skin grain may be characterized by relief, since the skin is not completely flat and presents relief at microscopic or millimetric scale, said relief being due to the natural presence of pores and of hairs. This relief may be referred to as the “original skin relief”.

As time goes by, hairs and folds may appear in the skin and also fine lines and orange peel type relief, for example. This relief may be referred to as “aged skin relief”.

Skin grain may also be damaged by disorders such as scars, acne, injuries, burns, stretchmarks, and light, in particular UV light. This relief may be referred to as “damaged skin relief”.

Skin grain may also be characterized by irregularities of color, likewise occurring at microscopic and/or millimetric scale. These color non-uniformities are generally due to differences of pigmentation. For example they may be beauty spots or freckles. They may also be small veins showing up as red color, or lack of pigmentation showing up as pale color. Color irregularities may be present at birth, and can then be referred to as “original skin color non-uniformities”.

Color non-uniformities may also change naturally over time. For example, some non-uniformities get worse over time, but others disappear. These may be referred to as “aged skin color non-uniformity”.

Color non-uniformities due to damage may appear over time and are referred to as “damaged skin color non-uniformities”.

When looking at skin from close up, and even from a greater distance, there can be seen the cumulative effects of relief, giving rise to effects of shade and light, and of color irregularities. These effects taken together are referred to as “skin grain appearance”.

Many people are unsatisfied with their skin grain appearance.

Sometimes, this applies to their skin as a whole, or else only to the skin of visible portions such as the face, the hands, the neck, or the bust.

There is no real solution for improving skin grain, other than covering the skin entirely in a masking composition. The effect is so artificial that it is necessary to limit the covering power of the compositions used, but under such circumstances improvement to skin grain is limited.

Even over a limited area, the impact of unsatisfactory skin grain can be significant and lead to complexes, for example when the skin appears to be pricked because of dilated pores on the cheeks, or for a man when bristles on the chin are irregular. By shaving, it is possible to make such irregularities disappear. However by the middle of the day, bristles start to reappear and the irregularity is made visible once more.

Acne spots or scars on certain locations of the face constitute another example of troublesome skin grain blemishes.

For people suffering from such blemishes, the solution consists in covering them with a masking composition, but that is not really satisfactory.

In some circumstances, it is possible to improve skin grain by surgical treatment. By acting on relief and sometimes on color, it is possible to obtain certain results. However surgery is not easily accepted and the results are not always attractive in appearance.

Furthermore, even in the absence of blemishes that are particularly visible, it may be advantageous to be able to change skin grain, even if the grain is found to be satisfactory. For example, regularity of color is not necessarily the most attractive, and certain irregularities can give character to a face, for example giving it a virile, experienced, or cheeky look. Furthermore, certain kinds of skin grain, such as freckles, for example, may be very attractive. To make such skin grain, no effective solution exists at present, other than passing hours with a makeup professional.

Publication WO 2007/02195 A1 discloses a method of applying makeup in which an agent that modifies the reflectance of the skin is applied to the skin by using ink jet printer technology. In one embodiment, the device includes a scanner and an ink jet printer, and in a single pass over the skin it analyses the skin, identifies unattractive characteristics, calculates the improvements to be made, and applies the agent that modifies reflectance so as to obtain those improvements. For example, the device can give a softer appearance to the skin by identifying pale and dark points and by applying the reflectance-modifying agent so as to darken pale points using a predefined averaging technique. The device may include means for recognizing the treated zone, e.g. the cheek bone or the cheek so that the improvements made are specific to the zone being treated, e.g. making cheeks look rosy so as to give the appearance of a person in better health, or darkening zones under the cheek bones so as to make them less prominent. A colorant may be deposited on certain portions of the skin to make it more uniform and markers that fluoresce under ultraviolet illumination may be used to make it easier to recognize certain regions during treatment. In an example seeking to simulate tanning, an agent that modifies the spectral characteristics of the skin is applied so as to reduce contrast between pale and dark zones, darkening zones of the skin in selective manner, while causing certain details of the skin to disappear. In another element, pale zones around wrinkles are darkened but the hollow zones within wrinkles are not modified.

Publication WO 2004/090629 A2 discloses a method of printing on the skin.

U.S. Pat. No. 6,543,893 describes an ink jet printer suitable for being moved manually over the skin. The printer may have a screen for displaying images that are to be printed and a device that enables the image to be personalized, e.g. by adding text or other information.

U.S. Pat. No. 6,622,723 describes an applicator having an ink jet printer head.

Application US 2006/0098076 discloses a system for ink jet printing on the skin that includes means for positioning the face. The printer system is suitable for printing hairs on the eyebrows or for printing color on the cheeks for blending in with a brush.

Application WO 02/01499 A2 describes a method of applying makeup by means of a movable applicator head supported by an arm that is articulated so as to follow the three-dimensional shape of the zone being made up. The three-dimensional shape is acquired with the help of one or more cameras. A design selected by the user can be printed using an ink jet. The printing may serve to cover a pigment mark with the same color as the surrounding skin, after performing colorimetric analysis thereon.

Application DE 10153249 A1 describes a method of applying compositions on the skin by means of an ink jet printing technique. Printing may be performed using a handpiece held by the user. In a variant, the print head may move relative to the skin by moving a belt or a carriage on a rail that is itself movable on two slideways at its ends.

Publication JP 2006-297691 discloses a printer system for printing an image on the skin, the system being fitted with means that enable the color of the skin to be measured. The printer system takes account of the color of the skin in the image that is to be reproduced, the print head being provided with a photodetector. For example, for a dark skin, the quantity of ink is increased. In a variant, not only is the lightness of the skin taken into consideration but also its color when calculating the image for printing.

Publication GB 2 343 657 describes a portable ink jet printer suitable for printing a mark authorizing entry to a concert or a discotheque on the forearm or the hand of a person. The ink that is deposited may be visible, fluorescent, magnetic, phosphorescent, or photochromic.

Application WO 02/00189 A1 describes a method of applying a colored composition on the skin in which it is possible to select a blemish on an image of the zone for treatment, which image is obtained by means of a camera that also measures color. Image modification software makes it possible to correct a blemish in the zone for treatment, e.g. a depigmented zone, by outlining the zone with the help of a computer mouse and then printing on the corrected zone the color of the surrounding zone.

Publication WO 03/032370 discloses an ink jet printer that can be positioned manually on the skin in order to print a tattoo.

Publication US 2007/0114306 describes an electrostatic spray device for making up the skin.

U.S. Pat. No. 7,190,550 discloses an installation capable of printing on the skin, in particular on the skin of the face.

Numerous appliances are also known for printing on the nails, e.g. from U.S. Pat. Nos. 5,931,166 and 6,035,860.

None of those known printer devices is entirely satisfactory, in particular for the purpose of obtaining makeup that is natural and varied.

### SUMMARY

There exists a need to modify or improve the appearance of human keratinous material in relatively easy manner, and more particularly but not exclusively to improve the appearance of skin grain.

The invention seeks to satisfy this need.

Exemplary embodiments of the invention provide a method of making up human keratinous material, the method comprising:
acquiring and storing a starting image and/or starting relief of keratinous material; and
reproducing on keratinous material of the same type an image for reproduction and/or relief for reproduction based on the starting image and/or relief, i.e. corresponding to the starting image and/or relief possibly after performing processing.

The term “keratinous material of the same type” should be understood as meaning skin, hair, lips, and fingernails, when the starting image and/or the starting relief is acquired respectively from the skin, the hair, the lips, and the fingernails.

The starting image and/or the starting relief may come from the same person as the person on whom the image and/or the relief is reproduced, or from a different person.

The image and/or the relief for reproduction may be reproduced at a second location that is different from the location at which starting image and/or relief acquisition took place. In various embodiments, the first and second locations do not overlap and may belay to different parts of the human body, for example one on the face and one outside the face.

The method may comprise displaying the device for reproduction before it is reproduced on the keratinous material.

The starting image may be acquired and the image for reproduction may be reproduced using a single apparatus, in the form of a handpiece.

The term “handpiece” should be understood as designating an article that can be handled by the user in one hand for image and/or relief acquisition and reproduction.

The image reproduction may simulate the presence of hairs or freckles. For example, such hairs or freckles may be absent from the starting image and may be added thereto.

The starting image or the starting relief may be subjected to processing in order to obtain the image or the relief for reproduction, the processing serving to eliminate skin blemishes, e.g. wrinkles, scars, traces of acne, . . . . The processing may be performed automatically, by image analysis.

Other exemplary embodiments of the invention also provide a device for making up human keratinous material, the device comprising:
a handpiece:
an acquisition and recording system for acquiring and recording at least one starting image and/or starting relief; and
a reproduction system for reproducing on the keratinous material an image for reproduction and/or for creating relief for reproduction, said image and/or said relief corresponding to the starting image and/or to the starting relief, possibly after processing has been applied thereto.

The reproduction system may be a printer system.

The invention enables makeup to be applied that gives a natural appearance to the skin, if that is so desired. Image capture and printing may be performed on the same person at the same time, thus making it easier to obtain rendering that is natural. Under such circumstances, the device may be used for example to capture an image of skin grain in a zone that the user finds attractive, and to print that image at other locations.

Image capture and printing may also be performed on two different people. This makes it possible to improve one's own skin grain or to discover the effects on oneself of some other kind of skin grain.

In an implementation of the method, the user may apply the device to the skin that the user considers to be the best suited for subsequent reproduction, and may carry out one or more capture operations. The user preferably chooses a location that presents some degree of similarity with the zone on which printing is to take place.

The device may display on its screen a simulation of the result of printing and the user may look at the result proposed by the device. After possible retouching or modification, the user may launch printing. The user may optionally reprint on the same surface without restarting capture or calculation, by making use of the memory of the device. Where appropriate, the user may also make use of a symmetry function for printing or reprinting a reversed image.

The user may also make use of the device for capturing data from some other person and reproducing the skin grain captured in this way on the user's own skin. If two people have devices of the same type, they may exchange skin grain. Person A captures his or her own skin grain and transmits it to person B who then prints it on his or her own skin.

The user may use the apparatus for capturing an image from a magazine or from nature, and, after processing, may print the device on his or herself.

The user may also use the device to capture the user's own skin grain at a certain date and reproduce it several years later in order to limit the effect of aging.

The device may be applied to bare skin or to skin that is already made up.

In addition to skin, the device may be used with other portions of the body, for example hair or fingernails. It may also be used secondarily for treating surfaces such as fabrics, wood, or plastics materials.

The device for reproduction may correspond to the starting image, without any transformation. Thus, the image that is printed is a faithful reproduction of the zone where acquisition was carried out. The quality of the printing may for example be such that, with the naked eye, a human observer does not perceive any difference in skin grain between the printed zone and the zone that served as the model.

The processing may seek in particular to modify the starting image and/or the starting relief or to extract skin grain therefrom. The term “extracting skin grain” is used to designate a sequence of computer processing operations that may include:

1) searching for points in the image of the skin that may be allocated to an effect of relief, e.g. points that are paler or points that are darker; and

2) searching for sets of points that form groups that repeat in relatively regular manner.

The processing may include a step consisting in recording all of the selected points as extracted skin grain.

The processing may also include the step consisting in selecting one such group and recording it as extracted skin grain.

The processing may also include a step consisting in averaging the shapes of a plurality of groups and selecting the average shape as extracted skin grain.

The processing may also consist in comparing points that have been selected with a skin grain bank and selecting a skin grain that is similar.

The skin grain obtained by the processing may be used for making the image for reproduction, e.g. by repetitively tiling the image with the skin grain as extracted in this way. Where appropriate, the tiling may be performed randomly so as to avoid the resulting image presenting an appearance that is too artificial. For example, the resulting image may include random variation in the spacing between individual elements of skin grain, or random variation in their intensity, or their shapes, or their directions.

The processing for modifying the starting device and/or the starting relief may be entirely automatic or it may be semi-automatic, thereby enabling the user to intervene on one or more processing parameters, for example the color and/or the clarity of the printing.

The processing may include automatically eliminating blemishes that are detected by image analysis. The device may be arranged to enable the user to act on at least one parameter controlling reproduction of the relief and/or of the device to be reproduced.

The device may be configured to evaluate the zone of skin that is subsequently to receive printing in order to adapt the device for printing thereto, so that it merges in as well as possible with the zone of skin that is to receive the printing. For this purpose, the processing may rely on reference points that are detected automatically or with manual assistance from the user, e.g. the corners of the nose, the eyebrows, thus enabling the visibility of the makeup to be reduced.

Image adaptation may make use of various kinds of processing, for example one or more offsets of the image, one or more rotations, reflections, scale changes, or other geometrical transformations.

The device may be in the form of a handpiece, thereby making it compact and practical to use.

The device may also be provided with sensors of various types, with each type of sensor possibly being present several times over. It is possible to perform data capture many times using the same capture system.

The device may be configured to enable the starting image and/or the starting relief, or the image for reproduction and/or the relief for reproduction to be backed up on storage means that are internal or external. This may facilitate subsequent utilization or data exchange with another person. The device may enable an image and/or relief for reproduction to be imported from an external data source.

The device may include a display system for displaying the image for reproduction before printing it. The display system may be carried on the above-mentioned handpiece, where appropriate.

The printer system may be an ink jet or a minispray system or it may involve printing by making contact with the keratinous material.

Other exemplary embodiments of the invention provide a method of making up the skin, the method comprising:
acquiring at least one image of a zone of the skin and/or data relating to the relief of a zone of the skin;
storing said image and/or said data;
waiting for the appearance of the zone of the skin to modify as a result of aging and/or the action of an external factor; and
making up the zone of skin by reproducing thereon an image and/or relief corresponding to the stored image and/or relief data, possibly after processing has been applied thereto.

By way of example, the waiting stage may exceed several months, or even several years.

The invention can be better understood on reading the following detailed description of non-limiting implementations thereof, and on examining the accompanying drawings, in which:

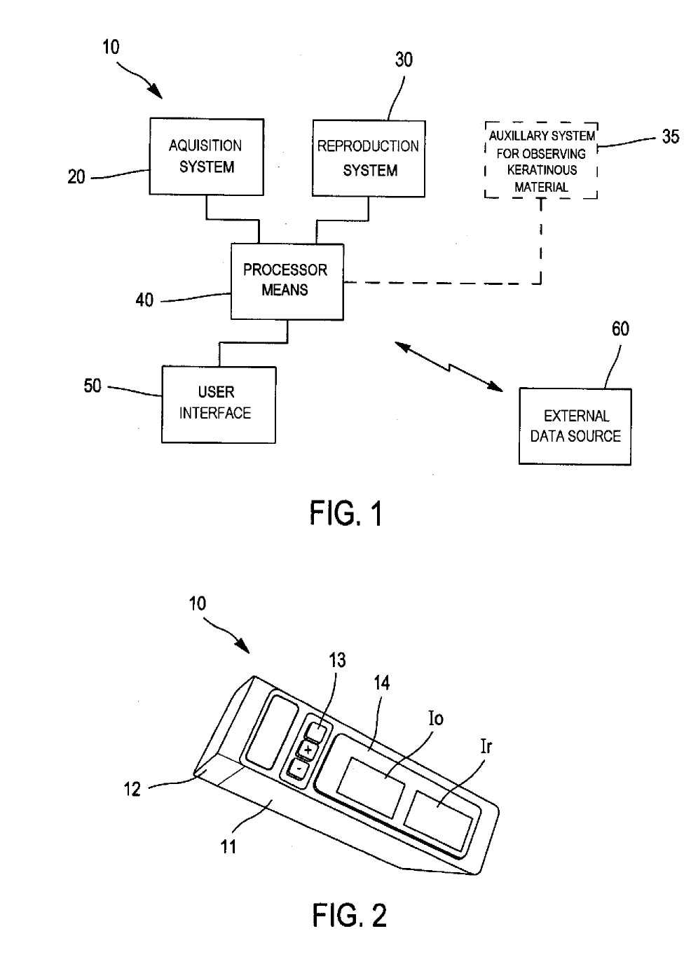

FIG. 1 is a block diagram of a device constituting an embodiment of the invention;

FIG. 2 is a diagrammatic perspective view of an embodiment of the device; and

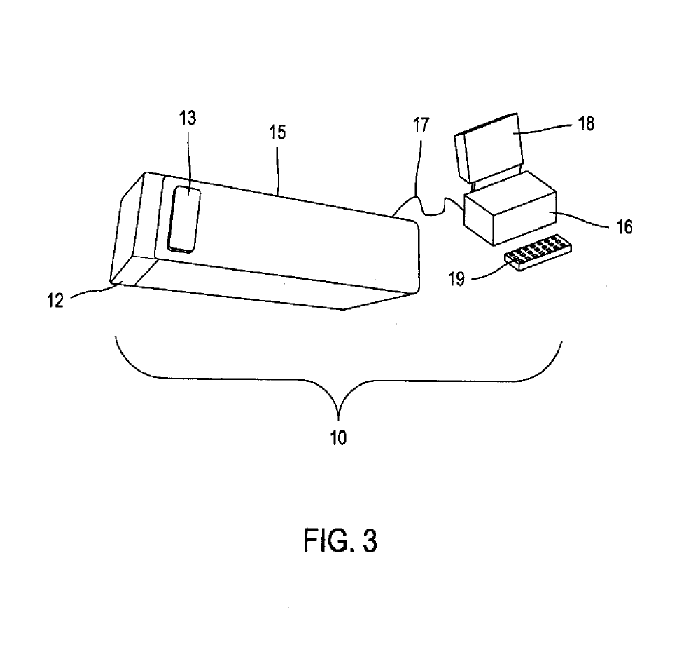

FIG. 3 is a view analogous to FIG. 2 showing a variant embodiment of the device.

The device 10 of the invention, shown diagrammatically in FIG. 1, comprises an acquisition system 20 for acquiring at least one starting image and/or starting relief, a reproduction system 30 for reproducing an image for reproduction and/or relief for reproduction, and processor mans 40 for making the device operate and optionally for processing the starting image and/or the starting relief prior to reproducing them on human keratinous material.

The device may optionally include an auxiliary observation system 35 for observing keratinous material.

In the diagram of FIG. 1, the system for observing keratinous material is represented in the form of a unit that is distinct from the acquisition system 20, however in practice it is possible to use the acquisition system 20 as the system 35 for observing keratinous material. The system 35 for observing keratinous material seeks to take account of the characteristics of the zone that receives the reproduction of the image and/or relief for reproduction so as to make the presence of makeup less easily detectable, for example.

By way of example, the data obtained by observing the skin makes it possible to print the image in an identified location on the zone of the skin for printing and/or to modify the image for reproduction, e.g. as a function of the color of the zone of skin that receives the image. Thus, if the apparatus is to reproduce an image acquired on a zone of skin that is relatively pale and if it is to print on a zone of skin that darker, then with the help of the observation system 35 and of computer processing, the device may be capable of recalibrating the color of the image for printing so as to make the color for printing come close to the color of the skin.

The device 10 also has a user interface 50 and may optionally communicate with an external data source 60, as described in greater detail below. The device may receive over a suitable connection a starting image that comes from a digital camera.

As shown in FIG. 2, the device 10 may be in the form of a handpiece arranged to be held by the user in one hand.

The device 10 may be brought up to keratinous material in order to acquire at least one starting image and/or starting relief. The device 10 may also be used in a configuration for printing on keratinous material for the purpose of reproducing an image and/or relief at a location that might be different from the location where acquisition takes place.

An image or relief may be reproduced on the keratinous material on the basis of a starting image and/or starting relief that was not obtained by acquisition from the individual who is to receive the printing, the starting image and/or the starting relief being, for example, present in a memory of the device 10 or being transmitted from another device 10 or from a remote site, e.g. a computer server. The starting image and/or starting relief may in particular come from a person famous for their beauty, from a magazine, or from some other information medium.

The device 10 may comprise a housing 11 that is preferably of ergonomic shape, being adapted to be held in the hand of the user.

The device 10 may include a head 12 for use in acquiring images and/or relief, and also for printing images and/or relief.

By way of example, the user interface 50 may comprise one or more selector buttons 13 and a screen 14, the screen serving for example to display a starting image Iₒ, e.g. as acquired by the acquisition system, and an image for printing Iᵣ, corresponding to the starting image Iₒ after processing, if any, and that may depend on actions carried out by the user, in particular on data input by the user.

The device 10 may equally well comprise a handpiece 15 and a base station 16 that communicate with each other, e.g. over a wired connection 17 as shown, or in a variant over a wireless connection. In the presence of a base station 16, the user interface on the handpiece 15 may be omitted or may be relatively limited, for example being reduced to one or more control buttons 13. The base station 16 may include a keyboard 19 and a screen 18 as a user interface.

The processor means may be shared between the handpiece 15 and the base station 16, with the base station being constituted by a microcomputer, for example.

The device 10 of the invention may also include a first portion that contains the acquisition system and a second portion that contains the printer system, with the first and second portions being suitable for handling separately by the user. At least one of these portions may include a memory for storing acquired data. The processor means may be shared between the first and second portions or they may be present within a base station that exchanges data with the first and second portions.

The device 10 includes a memory that may be analog or digital. Preferably, the device is provided with a memory that enables a plurality of data captures to be stored, preferably in a manner that is not volatile. The memory may form part of the processor means 40.

In an implementation of the invention, data capture and printing are performed at times that are spaced apart. For example, it is possible to capture images from various portions of the body and store them. During subsequent years, it is possible to print the images as stored in this way in memory or to make use of the stored images for processing them prior to printing. The invention thus makes it possible to capture skin grain prior to surgical or medical intervention. As a result, it is possible to reproduce the skin grain and rediscover beauty that has been spoilt by the intervention. The invention also serves to capture data concerning skin grain after natural treatment such as tanning for example, or after artificial treatment.

The invention may also serve to capture data concerning skin grain from an image in a magazine, or form a skin grain databank.

The portion of the handpiece that is placed on the skin, also referred to as the “contact portion”, may be plane or curved, for example in such a manner as to fit closely to the shape of a portion of the face or the body, e.g. a leg, an arm, a hand, the bust, the scalp, . . . .

Contact surfaces forming portions of a cylinder of a sphere are particularly suitable. The shape of the contact surface may be adapted in particular to the three-dimensional (3D) shape of the non-plane outlines of the face or the body. Where appropriate, the shape of the contact portion may be made to measure, after acquiring the three-dimensional shape of the user in the region that is to be treated.

The contact portion may be made out of flexible material so as to be capable of deforming to fit more closely to the region of the body or the face on which it is applied.

The printer and/or acquisition systems may be adapted to the non-plane shape of the treated region. For example, the or each line of printing may be designed to follow the non-plane shape of the skin, and may be provided with the option of moving, in particular in a direction perpendicular to the skin. Thus, the apparatus may have at least one print head configured to move under motor control and controlled electronically to move along the Z axis so as to follow the outline of the skin. A distance detector and/or a contact detector may serve to ensure that the distance between the printer system and the skin remains constant.

The device 10 may include safety systems such as a ground connection, a differential trip switch, a system for breaking a circuit in the event of a hatch being opened on the base station, if any, or on the handpiece.

The device 10 may be provided with a warning system providing information about proper positioning of the sensors on the skin, in particular a system that detects the absence of any gap and that provides information about proper positioning of the printer system relative to the skin. Thus, if the handpiece is no longer in contact with the skin, printing is stopped.

The device may also calibrate colors and printing in order to obtain good accuracy. Calibration may be an automatic function. Under such circumstances, either regularly or on each occasion that ink cartridges are changed, the apparatus performs test printing on a defined medium. The apparatus uses a color sensor, e.g. forming part of the acquisition system 20 or of the auxiliary observation system 35, if any, in order to determine the color of such printing and calculate calibration functions by comparing the result that was obtained with the result that was expected. Where appropriate, calibration may be refined manually.

A warning system may operate in the event of a malfunction of a component or of an ink being used up.

The device 10 may include a system for purging a print head after it has been used or for cleaning the color sensor(s) e.g. a pneumatic system.

The device 10 may be provided with a function for detecting that it has been put into place. This function enables the handpiece to detect whether it has been put into place on skin or on hair. This function may be performed in various ways. For example, the handpiece may be provided with contact detectors, e.g. based on thermal conductivity, on one or more photoreceivers, or on a pushbutton, there being four such detectors, for example. When all of the detectors detect contact, then the handpiece considers that it is in place.

The device 10 may make use of the acquisition means 20 to determine whether it is in place on the skin. Thus, before lighting is engaged, if the color detectors do not detect any light, then the device considers that it is in place.

The device 10 may include a visible or audible indicator for informing the user, e.g. that data capture or printing has been performed.

It is possible to provide the device 10 with an interface enabling information to be transmitted or received, whether with another device of the same type or with other apparatuses, via an ad hoc network, via the Internet, or via the telephone network.

The handpiece may optionally include an internal electrical power supply in the form of optionally rechargeable batteries or in the form of an electromagnetic or piezoelectric system that delivers the energy required for operating the device on being actuated.

Starting image acquisition system

As mentioned above, the device includes an acquisition system arranged to acquire relief from at least one location and also the appearance of a region of keratinous material. The relief and/or the image may be acquired from any zone of the skin of the body. The surface being subjected to acquisition may be flat or curved, and of greater or smaller size.

For example, a surface area restricted to a few square centimeters may suffice, particularly when the image for printing is reconstituted by multiple starting image zones. The surface subjected to acquisition may have an outline that is of square, rectangular, oval, or other shape.

The device may be arranged to capture an image of the skin in two dimensions (2D) or in 3D.

An image sensor may be used for performing acquisition, e.g. a digital camera.

The device may include an acquisition system implementing an optical system such as a converging lens, for example, together with a photosensitive system placed in its focal plane. The photosensitive system may have one or more sensors, e.g. a charge-coupled device (CCD) or a complementary metal oxide on silicon (CMOS) device, which may be in the form of a point, a line, or an array, e.g. having thousands or millions of pixels. The photosensitive system may be in the form of a line or a set of lines that serve to read the given area of the skin by moving the acquisition system over the skin.

Any system may be used for moving the line(s) of sensors, e.g. they may be moved flat or they may be moved in the manner of a rotating cylinder that is specially adapted to curve zones. For example, a detection cylinder may move on guides that present a certain amount of flexibility. By pressing the apparatus against the skin, the user can deform the guides to match the curvature of the face, thereby enabling the cylinder to follow the shape of the face.

The precision of acquisition may for example be of the order of 500 to 2500 pixels per centimeter. By way of example, it is possible to use sensors such as those used by the supplier E2V in cameras referenced Eliixa UC 8 or those from the supplier Dalsa having the reference ILC6.

The distances between the centers of the captured pixels may lie for example in the range 10 micrometers (μm) to 50 μm.

Acquisition may be performed with one or more black and white sensors, with color being reconstituted by performing data capture several times in succession under different lighting and/or through different filters.

The sensor(s) used is/are preferably sensitive to three color components, however they may also be sensitive to other wavelengths such as ultraviolet (UV) or infrared (IR). Thus, by way of example, it is possible to use the sensors used in Eliixa UC8-NIR cameras (E2V) that incorporate not only rows dedicated to red (R), green (G), and blue (B) colorimetric components, but also include a row of sensors that are sensitive to the near infrared (800 nanometers (nm) to 1100 nm).

It is also possible to use an acquisition system of the kind used in reprography, in photocopying, or in scanners.

### Lighting

The acquisition system preferably includes lighting, preferably using diffuse light. The lighting may be annular around the zone from which it is desired to acquire an image. It is possible to use light-emitting diodes (LEDs).

The lighting may be oriented and optionally adjustable so that the incident light is reflected towards the sensor(s).

The light may be at a grazing angle of incidence. The lighting may be continuous or pulsed. If lighting is provided in three color components, then the pulses for switching the lighting on and off may be controlled electronically.

It is possible to use one or more lenses for imaging the skin on the sensors, e.g. an array of microlenses obtained by molding a thermoplastic material.

Color capture is preferably made as independent as possible of effects associated with shadowing and reflection. For this purpose, action may be taken on the lighting and on the polarization of the lighting. In particular, the image may be captured under a plurality of lighting conditions and the device may extract color data concerning the surface by processing the images.

The device may be configured to limit the amount of ambient light reaching the sensor(s), e.g. by making use of a flexible opaque skirt that comes into contact with the skin around the zone from which the starting image is obtained.

The spacing between the skin and the acquisition system may be adjustable in order to enable a well-focused image to be formed.

It is possible to use a window or a grid for pressing against the skin during capture. The window or grid may be removable for ease of cleaning and may be plane or curved.

### System for Acquiring Relief

The device may include a sensor for sensing relief at millimeter or micrometer scale, preferably at a scale of less than one millimeter, and more preferably at a scale of less than 100 μm.

By way of example, it is possible to use one or more sensors of the feeler type. These may comprise, for example, a point that can be moved along X and Y axes parallel to the skin, with the movement of the point in a Z direction being measured while the point is kept in contact with the surface. For example, the point may scan the surface using the principle of the atomic force microscope (AFM).

There may also be a plurality of sensors that are placed on the skin, each sensor having a moving element that comes into contact with the skin, and with the movement thereof in the Z direction being measured.

The sensor(s) used may also be optical.

For example, it is possible to use one or more optical sensors that analyze a projection of fringes on the surface from which it is desired to acquire its three-dimensional shape. Computer processing then enables the 3D position of each point to be extracted.

Another possibility is to use the principle of confocal microscopy, in which images are captured going from focal plane to focal plane. This makes it possible to extract the 3D position of each point.

Preferably, the resolution corresponding to the finest details that the device can detect in relief lies in the range 1 μm to 1 mm, and preferably in the range 5 μm to 500 μm.

The color components and the 3D position of each point of the skin corresponding to a pixel of the starting image may be stored in memory.

In photocopying, systems exist for acquiring and printing images in which printing is performed electrostatically on a cylinder. The cylinder thus records information and can subsequently reproduce an image. The device according to exemplary embodiments of the invention may use a similar acquisition and printer system.

In preferred manner, the acquired data is stored in a digital memory, e.g. in integrated circuit form, in the form of an optical or a magnetic memory, e.g. random access memory (RAM), flash memory, a floppy disk, a compact disk (CD), or a digital versatile disk (DVD) or a hard disk. The memories used may be of various types. An internal stage of RAM may be used for example to store the acquired data during a period in which the device is used in uninterrupted manner.

A memory of the hard disk or optical disk type may be used for longer term storage of images. In this way, it is possible, for example, to record the skin grain of a child from an early age and continue with a sequence of such recordings. This data can be used subsequently at any age for making up skin that has aged.

### Printer System

Any printer technology can be used for the printer means.

Mention can be made in particular of offset printing, photogravure, flexography, silk-screen printing, pad printing, electrophotography (also known as xerography, electrostatic printing, or laser printing), thermal printing (including in particular simple thermal printing, thermal transfer printing, or thermal sublimation printing), elcography, toner jet, magnetography, ionography (also known as ion jet, electron beam imaging, or electrography), and ink jet printing (including in particular so-called “continuous ink jet” and “drop on demand” technologies).

Ink can be ejected as a jet or as droplets by a piezoelectric element, by a thermal element (bubble jet), by hot-melting, or by means of a valve (valve jet).

Mention may also be made of impact printing techniques, such as for example hammer or chain printing, needle or dot matrix printing, daisy wheel printing, thimble printing, and techniques such as minispray, gas printing, compressed air printing, liquefied gas printing, fluidized pressure printing, such as for example airbrushes or minisprays obtained by a moving part, e.g. a moving piezoelectric crystal.

The invention is better performed with contactless printing techniques, and in particular ink jet printing technologies and minispray techniques.

It is also possible to use printer means comprising a movable print element such as a sponge, a felt, a paint brush, a hollow tube, or a syringe, that contains ink that is put into contact with the skin for printing purposes. Contact time may be adjustable and may vary for example over the range 1/1000th of a second (s) to several seconds.

The term “printing” is used to mean delivering a composition onto the surface of the material for treatment, and in particular the skin. In the meaning of the invention, printing relates to delivering the composition onto or beneath the surface for treatment. Thus, printer means using needle printing technology can enable the ink to penetrate into the stratum corneum, the epidermis, or the dermis. For this purpose, it is possible to use strong needles or brittle needles, or the like.

The printer means may have a single print nozzle or a plurality of nozzles in parallel. The printer means may have nozzles that are dedicated to respective inks, or in a variant it may have a single nozzle for ejecting a plurality of different inks in succession or mixed together while printing is taking place so as to create the color that is to be printed.

The printer means may be spaced apart from the skin so as to avoid coming directly into contact with the skin. This spacing may be fixed or adjustable. It is possible to adjust the spacing either directly, e.g. by turning a knob or by acting on an adjustment button that controls the movement of a motor, or else automatically. For automatic adjustment, the processor unit controls a motor to change the spacing.

If it is desired to perform sharp printing, the spacing can be adjusted to a small value, e.g. one millimeter or less, and conversely, if it is desired to perform fuzzier printing it is possible to adjust the spacing to a greater distance, e.g. 1 cm or more.

The printer means may include a print head capable of printing over the entire surface for treatment. By way of example, the print head may include one or more ink ejection nozzles. Assuming that the user moves the appliance along an axis X, the print head may extend perpendicularly to the travel direction X of the apparatus.

The print head may be stationary within the apparatus or it may be movable along an axis Y that is perpendicular to the axis X. For example, the apparatus may be used to perform scanning in a Y direction of the print head with or without printing taking place during carriage return. The carriage may be driven by stepper motors, e.g. motors that are addressed directly by a USB port.

When the handpiece has a plurality of print heads that are stationary within the handpiece, the print heads may be in alignment or otherwise, for example they may be in a staggered configuration.

The handpiece may include printer means with at least one print head that is capable of moving relative to the above-mentioned carriage, along an axis Z that is perpendicular to the axes X and Y.

The print head may be actuated mechanically during printing, e.g. by means of a vibrator, in order to obtain a fuzzy effect.

The handpiece may include a vacuum or blower system in order to accelerate drying, and/or a heater system.

When the ink deposited on the keratinous material requires exposure to light radiation, e.g. UV radiation, in order to polymerize, the handpiece may include a corresponding lighting system for assisting the polymerization of the ink(s) concerned.

The printer means may have a print line made up of a plurality of print elements disposed along a print line. By way of example the print elements may be nozzles that enable the color for printing locally to be created on printing.

The printing may take place by depositing a plurality of inks of different colors in juxtaposed manner or in a manner that is at least partially superposed. The deposited slots of different inks may optionally have the same size.

The area of skin may be entirely covered by the ink(s), or gaps may be left between the deposits of ink. Inks may be deposited on the skin in a silk-screen configuration.

The image printed on the skin need not be uniform, i.e. printing may make use of at least one ink that is deposited in non-uniform manner over the area that is being treated.

The device may include a monitoring system enabling the user or the device to determine whether printing is satisfactory or whether printing needs to be continued or corrected. By way of example, the monitoring system uses the acquisition system or includes a specific color detector or camera. For example, the device may reproduce the skin that is being treated on a screen. Although hidden by the device, the skin can be viewed by the user, thereby enabling the user to access the result while it is being achieved.

Since the movement of the handpiece is not necessarily rectilinear, it is possible to provide for treatment that is “point-to-point” as opposed to “line-to-line” so that printing takes place in identified positions relative to the skin even if the path followed by the handpiece is curved.

### Inks

The device may print a deposit that is made up of one or more cosmetic inks.

The inks are adapted firstly to the printing technology and secondly to the color that is desired.

The inks used are preferably fluid and may be based on water or organic solvents and may include at least coloring agents selected from natural or artificial dyes, possibly fluorescent or phosphorescent, organic and/or inorganic pigments, and mixtures thereof.

The ink may include one or more non-colored materials that provide optical effects, e.g. a fuzzy effect.

Where appropriate, one of the printed compositions may be a base coat or a top coat in order to improve retention of the inks, for example.

The coloring agent(s) and the optically active colorless agent(s) may be in a dispersion, dissolved, or in an emulsion. They may also form a mixture that is not very stable, that needs to be remixed or redispersed at the time of use.

By way of example, the inks may be contained in a cartridge or a group of cartridges that is easy to remove and replace.

One or more color ink cartridges may be used, e.g. corresponding to primary colors (cyan, magenta, yellow, and black) or to colors that are close to skin color (pink, ochre, beige, ivory, brown, . . . ).

In an implementation of the invention, a single printer nozzle is used with a plurality of ink cartridges of predefined colors. For example it is possible to use 1 to 1,000 e.g. sixteen colored inks, representing a set of colors that are usually to be found on the skin: pale beige, yellowish beige, pinkish beige, . . . . All of the cartridges are connected to the printer nozzle, and the device modulates the rate at which each of the cartridges delivers ink to the printer nozzle as a function of the color to be printed, e.g. using electrostatic microfluidic technology.

### Reproduction of Relief

By way of example, the device includes a 3D polymerization system or a 3D ablation system, or both.

The device may be arranged in particular to create genuine relief on the skin by means of a photopolymerizable material.

By way of example, the techniques used are 2D or 3D laser polymerization. Depending on the light energy delivered, polymerization takes place to a greater or lesser depth. Femto lasers that deliver very high peak powers and thus make so-called “bi-photonic” polymerization possible, are well adapted for this purpose, but other optionally-pulsed lasers may be used.

It is possible to proceed with photopolymerization in separate focal planes.

Another approach is thermal ablation of sensitive material or mechanical ablation of modeling material.

The relief may be produced on the skin or it may be made separately from the skin and then brought up to the skin to be placed thereon and/or adhesively bonded.

### Processing

Processing may be performed by microcomputer, minicomputer, microcontroller, or any programmable electronic circuit, for example.

Color data and data concerning relief may be analyzed to determine whether the data makes sense, either compared with simple models (e.g. comparing each point with limit values, whether low or high) in order to eliminate outlier points, for example, or in comparison with models that are more complex, e.g. involving skin standards and proceeding with data comparisons. For example, color data may be analyzed in order to determine its distribution, e.g. a mean color and the distribution of the data about the average. The color data may also be analyzed to deduce the presence of measurement defects therefrom. For example, an isolated point that is completely different from its neighbors in terms of color may be considered as being unlikely. It is also possible to deduce skin blemishes therefrom, such as zones that are red or the presence of colors that are not natural, e.g. blue, green, or violet. More complex models may be used, e.g. it is not only colors that are compared but also the pattern formed by the points of color. Thus, it is possible to distinguish between a beauty spot and an age mark, for example.

The data concerning relief may also be compared with models in order to distinguish between natural relief such as wrinkles for example and relief that is not natural such as measurement artifacts, for example. Comparing shapes also makes it possible to distinguish between relief that is attractive such as a beauty spot or small wrinkles, and relief that is unattractive such as deep wrinkles, scars, or spots.

The processing may comprise using mathematical filters on pixels or groups of pixels in order to attenuate non-standard colors.

The device may be arranged to suggest that no image be printed if the device is of the opinion that the image does not make sense. For example, the device may be adjusted so that when the device presents a color defect, e.g. a large distribution of color or relief that may be unnatural or unattractive, a warning is given prior to printing. The warning may consist in switching on an LED, displaying a message on a screen, issuing an audible warning, or speaking a message.

The processing may use binning methods that consist in grouping pixels together in sets when taking measurements.

Colorimetric data or relief data may be smoothed or shaded off. By way of example, smoothing may consist in reducing the differences between colorimetric data items in a given zone. Shading off may consist in taking pairs of reference points and in calculating colors for points along a line between the two points in each reference pair. Colors may be calculated so that they progress from the color of the first point in the pair to the color of the second point in the pair.

Amongst the treatments that may be applied to the starting image and/or to the starting relief, mention may also be made of the following:
image formatting;
optional image retouching;
skin grain extraction;
making images on the basis of extracted skin grain;
calculating a modification to make skin grain look younger or older; and
calculating a modification that may be calculated to adapt skin grain to a particular portion of the body.

Images of extracted skin grain may be made by overlaying skin grain on a solid background, e.g. of flesh color or by overlaying skin grain on a background that has already been structured, e.g. an image of skin.

By way of example, skin grain may be overlaid by tiling each skin grain pattern in regular and spaced-apart manner, while also imparting a random contribution to this regularity and spacing so as to avoid the image appearing too regular.

A calculation for modifying skin grain to look younger or older may include a step that consists in attenuating or accentuating relief or colors. Thus, in the presence of dark points that may be interpreted as pores for example, the modification may consist in lightening the points, but without completely removing the pores, so that each pore becomes less visible.

The modification may also cause additional colors or relief to appear, such as dots, pores, wrinkles, scars, spots, beauty spots, and skin grain representing intact hairs or hairs that have been cut by shaving.

Calculation for modifying skin grain to adapt it to a particular part of the body may include a step consisting in asking the user on which part of the body printing is to take place. From there, the device may compare the skin grain with reference skin grain for that part of the body. If the device deduces from this comparison that the skin grain is unusual compared with the reference skin grain, it may propose modifications or wait to be given modifications to make. Thus, if printing is to take place on the cheek, the device may apply a modification calculation that includes a step consisting in enlarging the pores. If printing is to be performed on the forehead, the device may propose adding horizontal wrinkles.

As mentioned above, once an image has been captured on a zone of the skin, it is possible without any retouching to print that image on the skin, e.g. at some other location. It is also possible to format the image prior to reproducing it. For example, the image for reproduction may constitute a portion only of the starting image. It is also possible to pivot the starting image through a determined angle in order to form the image for reproduction.

An image for reproduction may be made by juxtaposing a single starting image several times or by juxtaposing different starting images. It is thus possible to make a mosaic of images in order to form the image that is to be reproduced.

Images may be merged in order to form the image that is to be reproduced.

It is possible to modify the hue, the saturation, or the clarity of the image prior to reproducing it by acting on one or more color components of the starting image. This modification may be performed on the basis of the mean skin color of the person or on the color of the skin facing the acquisition or printer system.

The image for reproducing may also be magnified or reduced, e.g. so as to correspond to the starting image with a magnification factor that is selectable by the user, e.g. over the range 10% to 1000%, preferably over the range 50% to 300%.

The image may be deformed.

The image may be made fuzzy and/or recolored.

It is also possible to increase or decrease contrast in the image for reproduction.

It is possible to perform retouching, either manually or automatically, so as to remove imperfections such as marks or wrinkles, or remove elements such as hairs, for example, or add elements such as freckles or a beauty spot in order to make the skin more beautiful.

The device may also be arranged to extract an image or a group of images from the data and subsequently to perform printing to give the appearance of skin grain. For example, it is possible to remove the background from the image so as to leave marks, in particular freckles, or to conserve pores and/or wrinkles.

The device may be arranged so as to enable the user to retain only one or some of the elements present in the starting image. This selection may be performed manually or it may be performed in accordance with preprogrammed criteria, that may be intuitive or in compliance with rules established by the user.

For example, the user may inform the device that it is to retain elements on the image that have a real size of less than 500 μpm. As a result, the device analyzes the image to determine whether an element is of a size greater than that limit, e.g. a freckle, or below that limit, e.g. a pore.

With automatic selection, the device may analyze the image to detect zones presenting wrinkles, for example, in order to omit them.

When making a selection in application of preprogrammed criteria, if the user is older than some predefined age, e.g. more than 50 years old, the device may itself decide not to retain wrinkles so that they are automatically eliminated from the image that is to be reproduced.

After skin grain has been extracted, the device may print it unchanged or may create an image based on the extracted skin grain.

For example, it is possible to use the device to print a skin grain mosaic. To avoid a repetitive appearance that looks artificial, the device may introduce random elements and/or combine skin grain elements, in particular at different scales. It is also possible to make the image for reproduction from stock images, and to print them unchanged or after they have been combined with the starting image.

Combination may be mere overlay. Under such circumstances, the starting image serves as background and the image for reproduction is superposed on the background image. This means that all or some of the points in the second image take the place of points in the background image. Overlay may also be performed with transparency. Under such circumstances, the points of the second image are averaged together with the points of the background image, and the device deduces therefrom the points for the resulting image.

With such overlay, it is possible to process the points of the background image and the points of the overlay image so as to accentuate the transparency effect and/or the fuzziness of the overlay.

The device may also be arranged to make an image with freckles, making marks of various different sizes.

In general, the appearance of images may be made to look older or younger by acting on the usual features that match skin state with age, e.g. microrelief, pores, and color irregularity.

It is also possible to modify an image by applying modifications thereto so that the image for reproduction merges well in a given zone of the skin where the image is to be reproduced. For example, if the skin is to be printed on a man's skin, it is possible artificially to add dark points to represent growing bristles. If printing is to be performed on the front face of the arm, often less tanned than the skin in general, it is possible to correct the color.

If the only data available concerns relief of a zone of the skin, it is still possible to print an image on the skin. For this purpose, it is possible to calculate the appearance that the skin ought to have as a function of the stored 3D shape. It is possible to take account of the fact that recessed zones may appear darker, and vice versa, so as to create shading effects. Once the image has been created, it is possible to use the same formatting or retouching as described above.

If data is available concerning relief of a zone of the skin together with data concerning its color, this data can be combined to create images that are particularly realistic.

In an implementation of the invention, the device may perform printing in relief. Such printing may be an accurate reproduction of acquired data relating to the three-dimensional shape of the skin.

Preferably, a mathematical transformation is applied to the acquired data so as to reduce the amplitude of the relief that is reproduced. For example, relative to a mean plane, the lowest portions may be situated at a depth of less than 1 mm and preferably of less than 500 μm. It is also possible to avoid reproducing relief that corresponds to starting relief data relating to a projecting portion.

Printing may be performed using a material that is transparent, but preferably it is performed using a colored material. One possibility is to reproduce relief using a transparent material and then to apply makeup. Other retouching may be performed on the printing in relief, as described above.

It is possible to combine printing in relief with printing using colored ink. Under such circumstances, and preferably, printing is performed first in relief and then in color.

In an implementation of the invention, when there is no data concerning the relief of the skin, it is possible to transform a color image or even a black and white image of the skin into data concerning relief, by considering dark zones and pale zones respectively as portions that are lower and portions that are higher.

### User Interface

The apparatus may display the starting image at a varying scale on the screen and simulate the expected result on the skin.

Preferably, the device is informed about the state of the zone of the skin on which printing will subsequently take place, e.g. by means of a questionnaire to be filled in or by measuring colorimetric data or by acquiring an image of the zone of skin that is to receive relief or printing.

By means of this data, the device is in a better position to calculate the printing it is to perform, in particular by determining a coverage power for the printing. For example, if the skin is marked or dark, it is preferable to use printing with greater covering power.

Knowledge of the optical properties of the zone that is to receive printing may be used for calculating the image for reproduction so as to optimize the result of the appearance of skin grain after printing. For this purpose, it is possible to rely on rules for superposing pixels, as described above.

### Proposed Example

### Acquisition System

A webcam was taken apart. The sensor portion, the integrated circuit, and the USB connection were installed in an aluminum frame. The camera lens was moved forwards by 2.2 mm from its initial position in the webcam.

The parts were secured in the aluminum frame so that the lens was flush therewith.

The frame was provided with a 20 mm long transparent plastics skirt. Thus, once placed on the skin, data capture took place at a distance of 20 mm from the skin.

Annular lighting was installed around the plastics skirt. A mask installed at the top of the skirt prevented light from reaching the sensor directly. The annular lighting was switched on as soon as the apparatus was switched on and it was powered by an incorporated battery.

### Printer System

A frame was made using perpendicular slideways and a carriage was installed thereon so as to travel along a first slideway under drive from a stepper motor under computer control. Movement was achieved by transforming rotation of the motor into horizontal movement via gearing and a rack system placed on the slideway.

The first slideway was mounted to travel on other slideways under drive from a second stepper motor, likewise under computer control. Movement was obtained by transforming rotation of the motor into axial movement by means of gearing and a rack system placed on the slideway.

In this example, the two motors were Performax 1CD models from the supplier Zeitlauf, including USB interfaces.

An ink printer was taken apart, for example a Canon Pixima 260 or an Epson PictureMate 240, and the mechanism and the bodywork were removed so as to retain only the print head with its print cartridges, and the electronics. Cosmetically acceptable inks were used.

The print head was mounted on the carriage so that the outlet from the print head was close to the front face of the apparatus. Thus, when the carriage moved, the print head was at all times flush with its base. The printer electronics were mounted on the frame at a distance sufficient to avoid interfering with movement of the carriage. The USB connection with the printer electronics was positioned on the casing of the movable portion.

### Processor Means

An embedded PC type ultracompact PC 104 from the supplier Advantech and having the reference PCM 4170 was used together with a 256 megabyte synchronous dynamic random access memory (SDRAM), a mouse, a screen, and an Internet connection. That PC has four USB extension ports and was provided with a 40 gigabyte hard disk emulator in the form of an EPROM.

The PC was operated by the Windows Embedded operating system together with drivers for the camera and the printer.

It had one USB port connected to the electronics of the camera, another USB to the electronics of the print head, and two USB ports connected to the two stepper motors.

The PC was provided with software enabling it to capture an image at the decision of the user, e.g. after inputting an instruction via the keyboard, using capture functions of Windows Embedded. The program serves to display the image on the screen and to store it. Retouching, e.g. by changing the color component of the image may be suggested. The image to be reproduced is then displayed on the screen in order to be accepted or refused.

The program serves to transform the user's choice into a print file using the bitmap or some other standard. This file is stored in memory. Printing is not activated until the user issues an instruction.

The program launches printing if the user is in agreement, controlling the delivery of the print file to the electronics of the print head and controlling the two motors so as to address each point and cause the carriage to return.

After printing has been finished, the device returns to a standby mode enabling the user either to leave the device inactive, or to restart printing, or to restart data capture.

The PC may also be programmed to store any image in memory and load it should the user so desire, from the hard disk emulator. The device may warn the user when data capture has been performed and when printing is ready to start or has been completed.

The user is not limited to the examples descried above.

The term “comprising a” should be understood as being synonymous with “comprising at least one”.

1-15. (canceled)

16. A method of making up human keratinous material, the method comprising:
acquiring at a first location and storing a starting image and/or starting relief of keratinous material; and
reproducing on keratinous material of the same type an image for reproduction and/or relief for reproduction corresponding to the starting image and/or relief, the image and/or relief for reproduction being reproduced at a second location that is different from the first location.

17. A method according to claim 16, the image for reproduction and/or relief for reproduction corresponding to the starting image and/or relief after performing processing.

18. A method according to claim 16, the image for reproduction or the relief for reproduction corresponding to the starting image or the starting relief without modification of the image or the relief.

19. A method according to claim 16, comprising displaying the image for reproduction prior to printing it on keratinous material.

20. A method according to claim 16, acquisition of the starting image and reproduction of the image for reproduction being performed by means of the same apparatus, in the form of a handpiece.

21. A method according to claim 17, the image for reproduction simulating the presence of hairs or freckles,

22. A method according to claim 17, the starting image or the starting relief being subjected to processing for eliminating the presence of skin blemishes in order to obtain the image or the relief for reproduction.

23. A method according to claim 16, wherein the starting image is printed after a duration at the end of which the keratinous material has aged sufficiently to change the appearance thereof significantly.

24. A method according to claim 23, the duration being greater than a year.

25. A device for making up human keratinous material, the device comprising:
a handpiece comprising:
an acquisition and recording system for acquiring and recording at least one starting image and/or starting relief; and
a reproduction system for reproducing on the keratinous material an image for reproduction and/or for creating relief for reproduction, said image and/or said relief corresponding to the starting image and/or to the starting relief.

26. A device according to claim 25, the image for reproduction and/or the relief for reproduction corresponding to the starting image and/or to the starting relief after processing has been applied thereto.

27. A device according to claim 25, the acquisition system including an optical sensor that is secured to the handpiece.

28. A device according to claim 25, configured to enable the starting image or the image for reproduction to be backed up on external storage means.

29. A device according to claim 25, enabling an image for reproduction to be imported from an external data source.

30. A device according to claim 25, including a display system for displaying the image for reproduction before it is printed.

31. A device according to claim 26, arranged to enable the user to act on at least one parameter for processing the starting relief and/or the starting image in order to obtain the relief for reproduction and/or the image for reproduction.

32. A device according to claim 25, the reproduction system implementing ink jet printing or minispray printing.
